(19) United States
(12) Patent Application Publication
(10) Pub. No.: US 2022/0237050 A1
(43) Pub. Date: Jul. 28, 2022

(54) SYSTEM AND METHOD FOR MANAGEMENT OF COMPOSED SYSTEMS USING OPERATION DATA

(71) Applicant: Dell Products L.P., Hopkinton, MA (US)

(72) Inventors: Joseph LaSalle White, San Jose, CA (US); William Price Dawkins, Lakeway, TX (US); Jimmy Doyle Pike, Georgetown, TX (US); Gaurav Chawla, Austin, TX (US); Elie Antoun Jreij, Pflugerville, TX (US); Mukund P. Khatri, Austin, TX (US)

(21) Appl. No.: 17/160,519

(22) Filed: Jan. 28, 2021

(51) Int. Cl. G06F 9/50; G06F 8/70

(52) U.S. Cl. CPC G06F 9/5077; G06F 8/70; G06F 9/505

(57) ABSTRACT

A composed system manager for managing operation of composed information handling systems includes storage for storing telemetry models for the composed information handling systems and a telemetry manager. The telemetry manager makes a determination that a composed information handling system of the composed information handling systems has been instantiated; in response to the determination, identifies resource set components allocated to the composed information handling system; generates a telemetry model of the telemetry models for the composed information handling system based on the resource set components; and configures the resource set components based on the telemetry model to aggregate operation data generated by the resource set components.

### BACKGROUND

Computing devices may provide services. To provide the services, the computing devices may include hardware components and software components. The services provided by the computing devices may be limited by these components.

### SUMMARY

In one aspect, a composed system manager for managing operation of composed information handling systems in accordance with one or more embodiments of the invention includes storage for storing telemetry models for the composed information handling systems and a telemetry manager. The telemetry manager makes a determination that a composed information handling system of the composed information handling systems has been instantiated; in response to the determination, identifies resource set components allocated to the composed information handling system; generates a telemetry model of the telemetry models for the composed information handling system based on the resource set components; and configures the resource set components based on the telemetry model to aggregate operation data generated by the resource set components.

In one aspect, a method for managing operation of composed information handling systems in accordance with one or more embodiments of the invention includes making a determination that a composed information handling system of the composed information handling systems has been instantiated; in response to the determination, identifying resource set components allocated to the composed information handling system; generating a telemetry model for the composed information handling system based on the resource set components; and configuring the resource set components based on the telemetry model to aggregate operation data generated by the resource set components.

In one aspect, a non-transitory computer readable medium in accordance with one or more embodiments of the invention includes computer readable program code, which when executed by a computer processor enables the computer processor to perform a method for managing operation of composed information handling systems. The method includes making a determination that a composed information handling system of the composed information handling systems has been instantiated; in response to the determination, identifying resource set components allocated to the composed information handling system; generating a telemetry model for the composed information handling system based on the resource set components; and configuring the resource set components based on the telemetry model to aggregate operation data generated by the resource set components.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1.1 shows a diagram of a system in accordance with one or more embodiments of the invention.

FIG. 1.2 shows a diagram of an information handling system in accordance with one or more embodiments of the invention.

FIG. 2 shows a diagram of hardware resources in accordance with one or more embodiments of the invention.

FIG. 3 shows a diagram of a system control processor in accordance with one or more embodiments of the invention.

FIG. 4 shows a diagram of a composed system manager in accordance with one or more embodiments of the invention.

FIG. 5 shows a flowchart of a method of instantiating composed information handling systems in accordance with one or more embodiments of the invention.

FIG. 6 shows a flowchart of a method of generating standardized telemetry packages for composed information handling systems in accordance with one or more embodiments of the invention.

FIGS. 7.1-7.4 show diagrams illustrating the operation of an example system over time in accordance with one or more embodiments of the invention.

FIG. 8 shows a diagram of a computing device in accordance with one or more embodiments of the invention.

### DETAILED DESCRIPTION

Specific embodiments will now be described with reference to the accompanying figures. In the following description, numerous details are set forth as examples of the invention. It will be understood by those skilled in the art that one or more embodiments of the present invention may be practiced without these specific details and that numerous variations or modifications may be possible without departing from the scope of the invention. Certain details known to those of ordinary skill in the art are omitted to avoid obscuring the description.

In the following description of the figures, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

In general, embodiments of the invention relate to systems, devices, and methods for providing computer implemented services. To provide computer implemented services, computing resources may need to be allocated for the performance of the services. The computing resources may include, for example, processing resources, memory, resources, storage resources, etc. These computing resources may be provided by any number of hardware devices referred to as resource set components when allocated to a system.

To allocate the computing resources, composed information handling systems may be instantiated. A composed information handling system may be a device (the components of which may be distributed across one or more information handling systems) that has exclusive use over a quantity of computing resources. Computing resources from multiple information handling systems may be allocated to a composed information handling system thereby enabling a composed information handling system to utilize computing resources from any number of information handling system for performance of corresponding computer implemented services.

When a composed system is operating, its operation may depend on the operational state of any number of resource set components allocated to it. Consequently, if any of these resource set components enter into undesirable operating states, the operation of the composed information handling system may be negatively impacted.

To manage the operation of the composed information handling system, a telemetry model may be generated. The telemetry model may be used to configure the resource set components allocated to the composed information handling system to provide operational data to an aggregation point. By aggregating operational data, an overall picture of the operation of the composed information handling system.

After the operation data is aggregated, the telemetry model may be used to transform the aggregated operation data into a standardized telemetry package. The standardized telemetry package may be a data structure that reports the operation of the composed information handling system as if it were a single device as opposed to being formed using resource set components from any number of information handling systems. By doing so, the composed information handling system may be managed using existing management entities (e.g., management applications). Consequently, composed information handling system may be managed similarly to existing devices.

For example, consider a scenario in which a composed information handling system is instantiated using resource set components from multiple information handling systems. Once instantiated, a composed system manager that is tasked with managing composed systems may make a determination that a composed information handling system has been instantiated. In response to the determination, the composed system manager may identify resource set components allocated to the composed information handling system. The composed system manager may generate a telemetry model for the composed information handling system based on the resource set components. Once generated, the composed system manager may configure the resource set components based on the telemetry model to aggregate telemetry data generated by the resource set components.

The resource set components may be configured by the composed system manager to send first operation data (e.g., telemetry data) to an aggregation point, such as the composed system manager or other device. Consequently, different resource set components from different information handling system may send the operation data to the same aggregation point. In some embodiments, intermediary collectors (e.g., system control processors, discussed below) may be used to collect and aggregate portions of the operation data and provide the aggregated collection to the aggregation point.

If the composed system manager is not the aggregation point, then it may program the aggregation point to generate, using the aggregated operation data and the telemetry model, a standardized telemetry package for the composed information handling system. The standardized telemetry package may have a format that would be generated by a telemetry generation entity hosted by an information handling system that hosts all of the resource set components. In other words, the resulting standardized telemetry package may appear as though it is for a traditional, non-distributed device. For example, the standardized telemetry package may be generated, in part, by replacing disparate source information associated with different portion of the telemetry data with a synthetic common source (e.g., a fictitious device). Consequently, the resulting standardized telemetry package may indicate that all of the aggregated operation data was obtained from a single bare metal device (as opposed to a distributed device that utilizes multiple layers of abstraction to stitch together its resources).

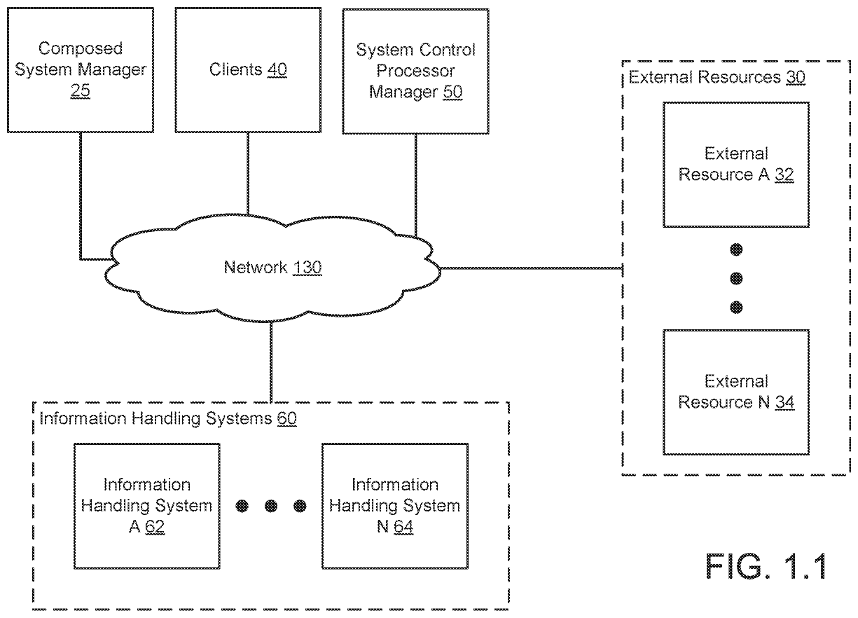

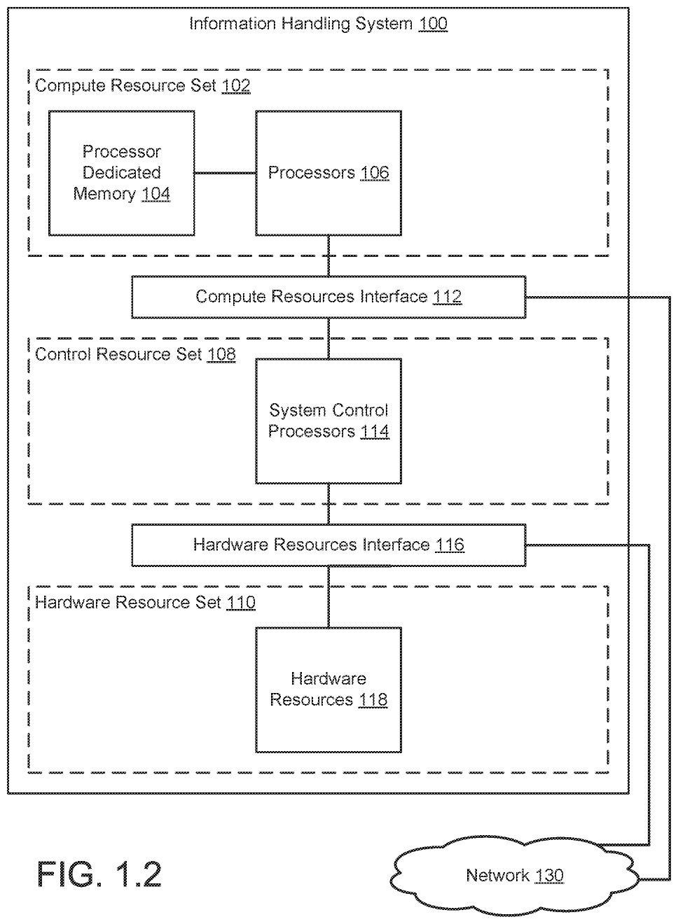

Turning to FIG. 1.1, FIG. 1.1 shows a system in accordance with one or more embodiments of the invention. The system may include any number of information handling systems (60). The information handling systems (60) may provide computer implemented services. The computer implemented services may include, for example, database services, data storage services, electronic communications services, data protection services, and/or other types of services that may be implemented using information handling systems.

The information handling systems of FIG. 1.1 may operate independently and/or cooperatively to provide the computer implemented services. For example, a single information handling system (e.g., 62) may provide a computer implemented service on its own (i.e., independently) while multiple other information handling systems (e.g., 62, 64) may provide a second computer implemented service cooperatively (e.g., each of the multiple other information handling systems may provide similar and or different services that form the cooperatively provided service).

To provide computer implemented services, the information handling systems (60) may utilize computing resources provided by hardware devices. The computing resources may include, for example, processing resources, storage resources, memory resources, graphics processing resources, communications resources, and/or other types of resources provided by the hardware devices. Various hardware devices may provide these computing resources.

The type and quantity of computing resources required to provide computer implemented services may vary depending on the type and quantity of computer implemented services to be provided. For example, some types of computer implemented services may be more compute intensive (e.g., modeling) while other computer implemented services may be more storage intensive (e.g., database) thereby having different computing resource requirements for these different services.

Clients (40) may request that the computer implemented services be provided. For example, the clients (40) may send requests to management entities to have the computer implemented services be provided.

In general, embodiments of the invention relate to systems, methods, and devices for managing the hardware resources of the information handling systems (60) and/or other resources (e.g., external resources (30)) to provide computer implemented services. The hardware resources of the information handling systems (60) may be managed by instantiating one or more composed information handling systems using the computing resources of the information handling systems (60), external resources (30), and/or other types of hardware devices operably connected to the information handling systems (60). Consequently, the computing resources allocated to a composed information handling system may be tailored to the specific needs of the services that will be provided by the composed information handling system. When specific hardware devices are allocated to a composed system, the allocated hardware devices may be referred to as resource set components.

When operating, the various hardware devices of the composed information handling systems may have different operating states. Some of these operating states may be desirable while others may not be desirable. For example, some operating states of the hardware devices may reduce the efficiency of performing computations, may render the computations performed by the information handling systems (60) to be incorrect, and/or may be undesirable for other reasons.

To manage the operating states of the hardware devices, the system of FIG. 1.1 may obtain information regarding the operation of the hardware components of the system. However, because these hardware components may reside in multiple, different information handling system (60), the system of FIG. 1.1 may configure these devices to send operation information (e.g., telemetry data) to a central point of aggregation. The aggregated operation information may then be transformed into a standardized format that represents the operation of what would be traditionally thought of as a single, bare metal device. By doing so, embodiments of the invention may enable composed information handling systems to be treated as single devices rather than distributed systems.

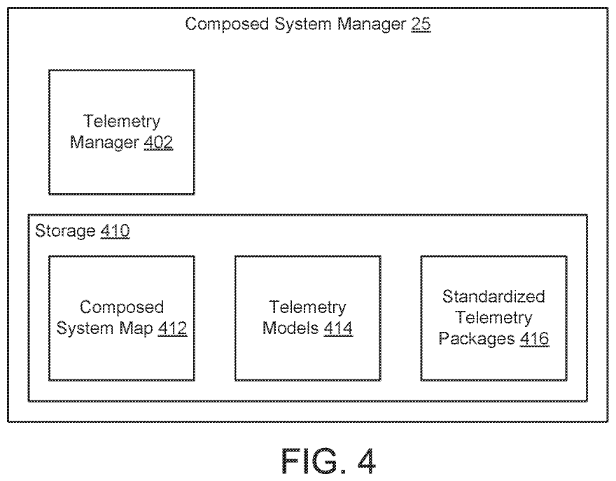

To enable operation information to be efficiently collected, the system of FIG. 1.1 may include a composed system manager (25). The composed system manager (25) may manage the process of setting operation data collection services and transformation of the collected data into a standardized format usable by a range of other applications. For additional details regarding the composed system manager (25), refer to FIG. 4.

To manage the operation of information handling systems, the system may include a system control processor manager (50). The system control processor manager (50) may provide composed information handling system management services. Composed information handling system management services may include (i) obtaining composition requests for composed information handling systems from, for example, the clients (40) and (ii) allocating computing resources from the information handling systems (60) and/or external resources (30) using system control processors to service the composition requests by instantiating composed information handling systems in accordance with the requests. By doing so, instantiated composed information handling systems may manage their operating states to maintain desired modes of operation.

The composed system manager (25) may operate in conjunction with or independently from the system control processor manager (50). For example, in some embodiments of the invention, when a new composed system is to be instantiated, the system control processor manager (50) may notify the composed system manager (25) and the composed system manager (25) may generate a telemetry collection model for the composed information handling system. The system control processor manager (50) may configure resource set components allocated to the composed information handling system in accordance with the model to cause operating data to be aggregated at an aggregation point (e.g., the composed system manager (25), an information handling system (e.g., 60), or another device).

In another example, after a composed information handling system is instantiated, the composed system manager (25) may directly configure the resource set components allocated to the composed information handling system to aggregate operation data at an aggregation point. For example, the composed system manager (25) may send communications to the composed information handling system which cause the composed information handling system to configure its resource set components to aggregate operation data at the aggregation point.

Returning to the discussion of the system control processor manager (50), it may instantiate the composed information handling systems in accordance with a three resource set model. As will be discussed in greater detail below, the computing resources of an information handling system may be divided into three logical resource sets: a compute resource set, a control resource set, and a hardware resource set. Different resource sets, or portions thereof, from the same or different information handling systems may be aggregated (e.g., caused to operate as a computing device) to instantiate a composed information handling system having at least one resource set from each set of the three resource set model.

By logically dividing the computing resources of an information handling system into these resource sets, different quantities and types of computing resources may be allocated to each composed information handling system thereby enabling the resources allocated to the respective information handling system to match performed workloads. Further, dividing the computing resources in accordance with the three set model may enable different resource sets (each including any number of resource set components) to be differentiated (e.g., given different personalities) to provide different functionalities. Consequently, composed information handling systems may be composed on the basis of desired functionalities rather than just on the basis of aggregate resources to be included in the composed information handling system.

Additionally, by composing composed information handling systems in this manner, the control resource set of each composed information handling system may be used to consistently deploy management services across any number of composed information handling systems. Consequently, embodiments of the invention may provide a framework for unified security, manageability, resource management/composability, workload management, and distributed system management by use of this three resource set model. For example, entities tasked with monitoring the health of computing resources of the composed information handling systems may be deployed in control resource sets. Accordingly, the health of these computing resources for providing computer implemented services requested by the clients (40) may be uniformly monitored across the information handling systems (60).

Similarly, the control resource sets of each composed information handling system may cooperate with the composed system manager (25) and/or system control processor manager (50) to configure resource set components to aggregate operation information (e.g., telemetry data) at an aggregation point. By doing so, embodiments of the invention may provide a transparent method of aggregating telemetry data from a disparate array of resource set components hosted by any number of information handling systems thereby enabling a repository of operation information for composed information handling systems to be obtained.

Further, the control resource set of each composed information handling system may be configured to assist in the collection and aggregation of operation data. For example, the control resource sets may collect operation data from any number of resource set components (actively or passively) and provide the collected operation to the aggregation point (rather than rely on the resource set components alone to aggregate the operation data).

In one or more embodiments of the invention, a composed information handling system is a device that is formed using all, or a portion, of the computing resources of the information handling systems (60), the external resources (30), and/or other types of hardware devices operably connected to the information handling systems (60). The composed information handling system may utilize the computing resources allocated to it to provide computer implemented services. Consequently, any number of resource set components from any number of information handling systems may generate operation data that is relevant to ascertaining the operation of a composed information handling system as a whole.

To instantiate composed information handling systems, the information handling systems (60) may include at least three resource sets including a control resource set. The control resource set may include a system control processor. The system control processor of each information handling system may coordinate with the system control processor manager (50) to enable composed information handling systems to be instantiated. For example, the system control processor of an information handling system may manage telemetry data regarding the computing resources of an information handling system (e.g., types, capabilities, and quantities of resource set components), may perform actions on behalf of the system control processor manager (50) to aggregate computing resources together, may monitor the utilization and/or activity of computing resources for providing computer implemented services requested by the clients (40), and/or may provide services that unify the operation of composed information handling systems.

In one or more embodiments of the invention, compute resource sets of composed information handling systems are presented with bare metal resources by control resource sets even when the presented resources are actually being managed using one or more layers of abstraction such as emulation, virtualization, indirection, security model, data integrity model, etc. For example, the system control processors of the control resource sets may provide the abstraction, emulation, virtualization, indirection, and/or other services while presenting the resources as bare metal resources. Consequently, these services may be transparent to applications hosted by the compute resource sets of composed information handling systems thereby enabling uniform deployment of such services without requiring implementation of control plane entities hosted by the compute resource sets of the composed information handling systems.

By virtue of providing these layers of abstraction, the control resource set may monitor the operation of any number of resource set components and may facilitate transmission of operation data of resource set components to an aggregation point. For example, when a processor needs to communicate with a hard disk drive of a hardware resource set, the communications may be routed through the control resource set. Consequently, the control resource set may transparently intercept these communications and perform analysis of these communications to identify the operating state of the processor and/or hard disk drive.

The external resources (30) may provide computing resources that may be allocated for use by composed information handling systems. For example, the external resources (30) may include hardware devices that provide any number and type of computing resources. The composed information handling system may use these resources to provide their functionalities. For example, system control processors may operably connect to and manage the external resources (30) to provide additional and/or different computing resources from those available to be provided only using hardware resource sets of information handling systems. By utilizing system control processors to manage these resources, the use of these external resources (30) for providing services requested by the clients (40) may also be efficiently and transparently monitored.

Different external resources (e.g., 32, 34) may provide similar or different computing resources. For example, some external resources may include large numbers of hard disk drives to provide storage resources while others may include graphics processing unit rendering farms. The external resources (30) may include any number and type of computing resources for allocation to composed information handling systems via system control processors of control resource sets. The control resource sets may similarly mediate communications between different resource sets of the information handling systems and the external resources (30) thereby enabling the control resource sets to facilitate transmission of operation data from these components to an aggregation point.

The system of FIG. 1.1 may include any number of information handling systems (e.g., 62, 64), any number of external resources (e.g., 32, 34), and any number of system control processor managers (e.g., 50). Any of the components of FIG. 1.1 may be operably connected to any other component and/or other components not illustrated in FIG. 1.1 via one or more networks (e.g., 130). The networks may be implemented using any combination of wired and/or wireless network topologies.

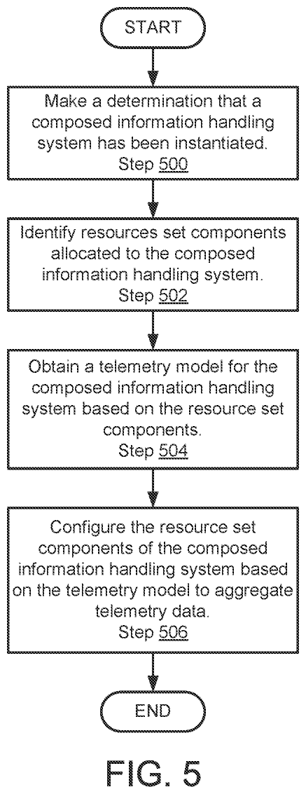

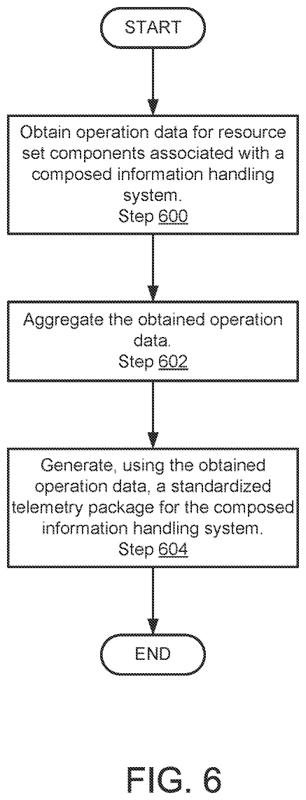

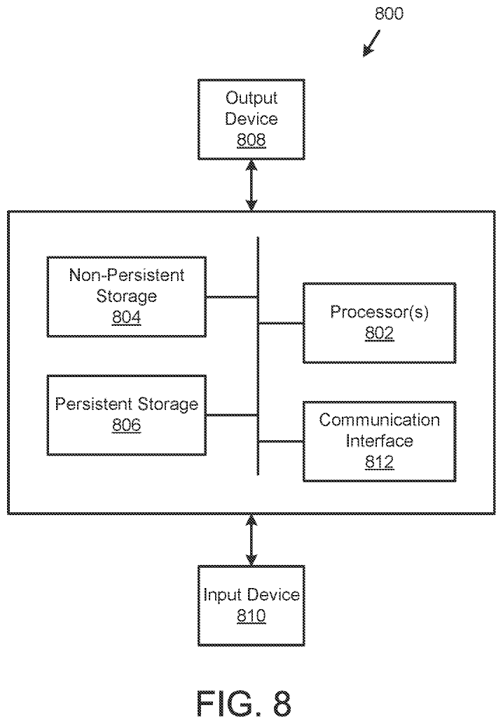

The composed system manager (25), clients (40), system control processor manager (50), information handling systems (60), and/or external resources (30) may be implemented using computing devices. The computing devices may include, for example, a server, laptop computer, a desktop computer, a node of a distributed system, etc. The computing device may include one or more processors, memory (e.g., random access memory), and/or persistent storage (e.g., disk drives, solid state drives, etc.). The persistent storage may store computer instructions, e.g., computer code, that (when executed by the processor(s) of the computing device) cause the computing device to perform the functions of the system control processor manager (50), information handling systems (60), and/or external resources (30) described in this application and/or all, or a portion, of the methods illustrated in FIGS. 5-6. The composed system manager (25), clients (40), system control processor manager (50), information handling systems (60), and/or external resources (30) may be implemented using other types of computing devices without departing from the invention. For additional details regarding computing devices, refer to FIG. 8.

While the system of FIG. 1.1 has been illustrated and described as including a limited number of specific components, a system in accordance with embodiments of the invention may include additional, fewer, and/or different components without departing from the invention.

Turning to FIG. 1.2, FIG. 1.2 shows a diagram of an information handling system (100) in accordance with one or more embodiments of the invention. Any of the information handling systems (e.g., 60) of FIG. 1.1 may be similar to the information handling system (100) illustrated in FIG. 1.2.

As discussed above, the information handling system (100) may provide any quantity and type of computer implemented services. To provide the computer implemented services, resources of the information handling system may be used to instantiate one or more composed information handling systems. The composed information handling systems may provide the computer implemented services.

To provide computer implemented services, the information handling system (100) may include any number and type of hardware devices including, for example, one or more processors (106), any quantity and type of processor dedicated memory (104), one or more system control processors (114), and any number of hardware resources (118). These hardware devices may be logically divided into three resource sets including a compute resource set (102), a control resource set (108), and a hardware resource set (110).

The control resource set (108) of the information handling system (100) may facilitate formation of composed information handling systems and management of the operation of the information handling system (100). To do so, the control resource set (108) may prepare any quantity of resources from any number of hardware resource sets (e.g., 110) (e.g., of the information handling system (100) and/or other information handling systems) for presentation to processing resources of any number of computing resource sets (e.g., 102) (e.g., of the information handling system (100) and/or other information handling systems). Once prepared, the control resource set (108) may present the prepared resources as bare metal resources to the processors (e.g., 106) of the allocated computing resources. By doing so, a composed information handling system may be instantiated. The control resource set (108) may due so based on the direction of a system control processor manager (e.g., 50, FIG. 1.1) and/or a composed system manager (e.g., 25, FIG. 1.1).

To prepare the resources of the hardware resource sets for presentation, the control resource set (108) may employ, for example, virtualization, indirection, abstraction, and/or emulation. These management functionalities may be transparent to applications hosted by the resulting instantiated composed information handling systems. Consequently, while unknown to the control plane entities of the composed information handling system, the composed information handling system may operate in accordance with any number of management models thereby providing for unified control and management of composed information handling systems. These functionalities may be transparent to applications hosted by composed information handling systems thereby relieving them from overhead associated with these functionalities.

For example, consider a scenario where a compute resource set is instructed to instantiate a composed information handling system including a compute resource set and a hardware resource set that will contribute storage resources to the compute resource set. The compute resource set may virtualize the storage resources of the hardware resource set to enable a select quantity of the storage resources to be allocated to the composed information handling system while reserving some of the storage resources for allocation to other composed information handling systems. However, the prepared storage resources may be presented to the compute resource set as bare metal resources. Consequently, the compute resource set may not need to host any control plane entities or otherwise incur overhead for utilizing the virtualized storage resources (e.g., the compute resource set may send bare metal communications to the control resource set, the control resource set may translate those bare metal communications into prepared resource compatible communications, and the control resource set may send the prepared resource compatible communications to the hardware resource set).

The control resource set (108) may also enable the utilization of any of the hardware components of the information handling system (100) by respective clients. When a composed information handling system is instantiated, it (and its hardware devices) may be utilized by a client by enabling the client to load application onto the composed information handling system. For example, the client may cause the composed information handling system to execute applications on the compute resource set (102) which, in turn, may utilize any number of compute and/or hardware resource sets (e.g., 110) as part of their execution.

Because the control resource set (108) may mediate utilization of hardware resource sets (110) by compute resource sets (102), the control resource set (108) may transparently ascertain the utilization of the hardware devices (collectively referred to as resource set components of a composed information handling system) of these resource sets. To do so, the control resource set (108) may intercept (as part of presenting computing resources of hardware resource sets to compute resource sets) communications between resource sets which may be used to infer the utilization of these hardware devices.

Additionally, control resource set (108) may act as a local entity which configures the resource set components to send operation data to an aggregation point. For example, the control resource set (108) may configure the resource set components in accordance with a telemetry model generated by a composed system manager (e.g., 25, FIG. 1.1). The telemetry model may specify which resource set components are to send operation data and where the operation data is to be sent.

The control resource set (108) may independently or in conjunction with the composed system manager decide how to configure the resource set components to meet the specification of the telemetry model. For example, the control resource set (108) may decide whether a resource set component can be configured to independently send operation data to an aggregation point or a resource set component should provide the operation data to the control resource set which will, in turn, provide the operation data to the aggregation point.

Resource set components may be configured by specifying (i) what type of data to provide (e.g., health information, operational state information, etc.), (ii) how the data should be collected (e.g., sampling rate), (iii) where the collected data should be sent (e.g., to an aggregation point or other entity to relay it to an aggregation point), (iv) actions to take in response to collecting predetermined types of data (e.g., triggering additional collection/different types of collection/automatically initiated remediation actions such as resets, reconfigurations, etc.), and/or (v) configuring other components to facilitate aggregation of operation data (e.g., instructing components to act as relays, to collect data regarding a resource set component such as communications, etc.). By configuring the resource set components, operation data for an instantiated composed information handling system may be aggregated regardless of where each of the allocated resource set components resides).

The compute resource set (102) may include one or more processors (106). The processors (106) of the compute resource set (102) may be operably connected to one or more system control processors (114) of the control resource set (108). For example, the processors (106) may be connected to a compute resource interface (112), which is also connected to the system control processors (114). The compute resource interface (112) may enable the processors (106) to communicate with other entities via bare metal communications. Also, the compute resource interface (112) may enable system control processors (114) of the control resource set (108) to monitor the activity and/or utilization of the processors (106) and/or processor dedicated memory (104). For example, the compute resources interface (112) may support sideband communications to the hardware devices of the compute resource set (102) thereby enabling health information for these hardware devices to be obtained by the system control processors (114) (e.g., to obtain health data to supplement the information obtained by monitoring communications between the processors (106) and/or other resource set components) thereby facilitating further collection of operation data regarding the resource set components (as opposed to self-reported data).

The system control processors (114) of the control resource set (108) may present computing resources to the processors (106) as bare metal resources. In other words, from the point of view of the processors (106), any number of bare metal resources may be operably connected to it via the compute resources interface (112) when, in reality, the system control processors (114) are operably connected to the processors (106) via the compute resources interface (112). In other words, the system control processors (114) may manage presentation of other types of resources (e.g., computing resources of the hardware resource set (110), external resources, other hardware resource sets of other information handling systems, etc.) to the compute resource set (102).

By presenting the computing resources to the processors as bare metal resources, control plane entities (e.g., applications) such as hypervisors, emulators, and/or other types of management entities may not need to be hosted (e.g., executed) by the processors (106) for the processors (106) and entities hosted by them to utilize the computing resources allocated to a composed information handling system. Accordingly, all of the processing resources provided by the compute resource set (102) may be dedicated to providing the computer implemented services.

For example, the processors (106) may utilize mapped memory addresses to communicate with the bare metal resources presented by the system control processors (114) to the processors (106). The system control processors (114) may obtain these communications and appropriately remap (e.g., repackage, redirect, encapsulate, etc.) the communications to the actual hardware devices providing the computing resources, which the processors (106) are interacting with via the compute resources interface (112) and/or hardware resources interface (116), discussed below. Consequently, indirection, remapping, and/or other functions required for resource virtualization, emulation, abstraction, or other methods of resource allocation (other than bare metal) and management may not need to be implemented via the processors (106).

By doing so, any number of functions for a composed information handling system may be automatically performed in a manner that is transparent to the control plane. Accordingly, a composed information handling system may operate in a manner consistent with a unified, consistent architecture or model (e.g., communications model, data storage model, etc.) by configuring the operation of one or more system control processors in a manner consistent with the architecture or model. The architecture or model may define, for example, when and how components communicate with one another, when and how resources are allocated, etc.

In one or more embodiments of the invention, control plane entities utilize computing resources presented through one or more layers of indirection, abstraction, virtualization, etc. In other words, an indirect use of hardware devices and computing resources provided thereby. In the information handling system of FIG. 1.2, the system control processors (114) may present abstracted resources, indirection layers, virtualization layers, etc. as bare metal resources.

In one or more embodiments of the invention, data plane entities directly utilize computing resources. For example, data plane entities may instruct hardware devices on their operation thereby directly utilizing computing resources provided thereby. Data plane entities may present the computing resources to control plane entities using one or more layers of indirection, abstraction, virtualization, etc.

The system control processors (114) may present any number of resources operably connected to it (e.g., the hardware resource set (110)), other resources operably connected to it via an interface (e.g., hardware resources interface (116), etc.) as bare metal resources to the processors (106) of the compute resource set (102). Consequently, the system control processors (114) may implement device discovery processes compatible with the processors (106) to enable the processors (106) to utilize the presented computing resources. Accordingly, the control plane of a composed information handling system may believe that any number of resources may be directly accessible as bare metal resources even when the resources are, for example, hosted by other information handling systems and managed using any number of layers of abstraction.

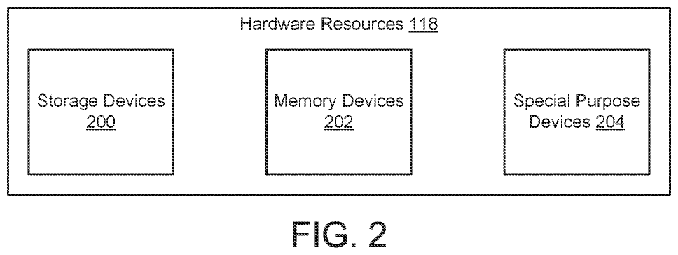

For example, the hardware resource set (110) may include hardware resources (118) operably connected to the system control processors (114) via a hardware resources interface (116). The hardware resources (118) may include any number and type of hardware devices that provide computing resources. For additional details regarding the hardware resources (118), refer to FIG. 2.

In another example, the system control processors (114) may be operably connected to other hardware resource sets of other information handling systems via hardware resources interface (116), network (130), and/or other system control processors of the other information handling systems. The system control processors may cooperatively enable hardware resource sets of other information handling systems to be prepared and presented as bare metal resources to the compute resource set (102).

In an additional example, the system control processors (114) may be operably connected to external resources via hardware resources interface (116) and network (130). The system control processors (114) may prepare and present the external resources as bare metal resources to the compute resource set (102).

The system control processors (114), by presenting resources to the compute resource set (102), may be able to monitor the utilization of the presented resources in a manner that is transparent to the applications or other entities executing using the processors (106). Consequently, these entities may not be able to interfere with monitoring of the use of these resources. In contrast, if an agent or other entity for monitoring computing resource health is executing using the processors (106), other entities executing using the processors (106) may be able to interfere with the operation of the monitoring entity. Accordingly, embodiments of the invention may provide a method of monitoring the operation of control resource set components that is less susceptible to interference by other entities while enabling operation data that is not self-reported by the resource set components to be collected and aggregated with other types of operation data (e.g., collected by a system control processor (114) and provided to an aggregation point).

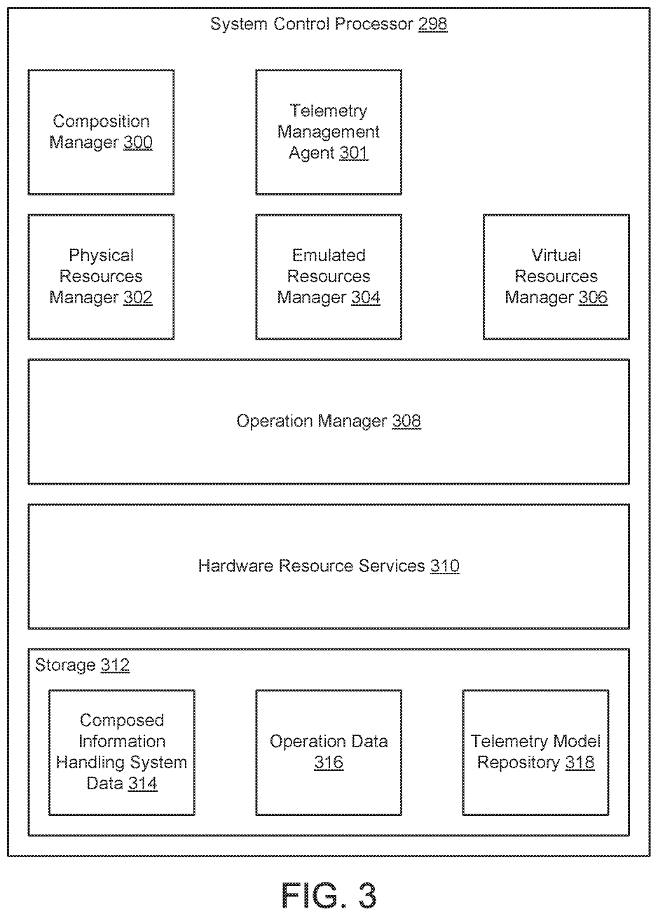

For additional details regarding the operation and functions of the system control processors (114), refer to FIG. 3.

The compute resources interface (112) may be implemented using any suitable interconnection technology including, for example, system buses such as compute express links or other interconnection protocols. The compute resources interface (112) may support any input/output (IO) protocol, any memory protocol, any coherence interface, etc. The compute resources interface (112) may support processor to device connections, processor to memory connections, and/or other types of connections. The compute resources interface (112) may be implemented using one or more hardware devices including circuitry adapted to provide the functionality of the compute resources interface (112).

The compute resources interface (112) may also support sideband communications between the system control processors (114), the processors (106), and/or the processor dedicated memory (104). Consequently, the system control processors (114) may be able to monitor (e.g., via collection of telemetry data) the operations of these other devices to identify the operation, health, and/or other characteristics of these hardware devices.

The hardware resources interface (116) may be implemented using any suitable interconnection technology including, for example, system buses such as compute express links or other interconnection protocols. The hardware resources interface (116) may support any input/output (TO) protocol, any memory protocol, any coherence interface, etc. The hardware resources interface (116) may support processor to device connections, processor to memory connections, and/or other types of connections. The hardware resources interface (116) may be implemented using one or more hardware devices including circuitry adapted to provide the functionality of the hardware resources interface (116).

In some embodiments of the invention, the compute resource set (102), control resource set (108), and/or hardware resource set (110) may be implemented as separate physical devices. In such a scenario, the compute resources interface (112) and hardware resources interface (116) may include one or more networks enabling these resource sets to communicate with one another. Consequently, any of these resource sets (e.g., 102, 108, 110) may include network interface cards or other devices to enable the hardware devices of the respective resource sets to communicate with each other.

In one or more embodiments of the invention, the system control processors (114) support multiple, independent connections. For example, the system control processors (114) may support a first network communications connection (e.g., an in-band connection) that may be allocated for use by applications hosted by the processors (106). The system control processors (114) may also support a second network communications connection (e.g., an out-of-band connection) that may be allocated for use by applications hosted by the system control processors (114). The out-of-band connection may be utilized for management and control purposes while the in-band connection may be utilized to provide computer implemented services. These connections may be associated with different network endpoints thereby enabling communications to be selectively directed toward applications hosted by the processors (106) and/or system control processors (114). As will be discussed in greater detail with respect to FIG. 3, the system control processors (114) may utilize the out-of-band connections to communicate with other devices to manage (e.g., instantiate, monitor, modify, etc.) composed information handling systems.

The network (130) may correspond to any type of network and may be operably connected to the Internet or other networks thereby enabling the information handling system (100) to communicate with any number and type of other devices.

The information handling system (100) may be implemented using computing devices. The computing devices may be, for example, a server, laptop computer, desktop computer, node of a distributed system, etc. The computing device may include one or more processors, memory (e.g., random access memory), and/or persistent storage (e.g., disk drives, solid state drives, etc.). The persistent storage may store computer instructions, e.g., computer code, that (when executed by the processor(s) of the computing device) cause the computing device to perform the functions of the information handling system (100) described in this application and/or all, or a portion, of the methods illustrated in FIGS. 5-6. The information handling system (100) may be implemented using other types of computing devices without departing from the invention. For additional details regarding computing devices, refer to FIG. 8.

While the information handling system (100) has been illustrated and described as including a limited number of specific components, an information handling system in accordance with embodiments of the invention may include additional, fewer, and/or different components without departing from the invention.

Turning to FIG. 2, FIG. 2 shows a diagram of the hardware resources (118) in accordance with one or more embodiments of the invention. As noted above, system control processors of information handling systems may present resources including, for example, some of the hardware resources (118) to form a composed information handling system.

The hardware resources (118) may include any number and types of hardware devices that may provide any quantity and type of computing resources. For example, the hardware resources (118) may include storage devices (200), memory devices (202), and special purpose devices (204) (the aforementioned being referred to as resource set components when incorporated into a composed information handling system).

The storage devices (200) may provide storage resources (e.g., persistent storage) in which applications hosted by a composed information handling system may store data including any type and quantity of information. The storage devices (200) may include any type and quantity of devices for storing data. The devices may include, for example, hard disk drives, solid state drives, tape drives, etc. The storage devices (200) may include other types of devices for providing storage resources without departing from the invention. For example, the storage devices (200) may include controllers (e.g., redundant array of disk controllers), load balancers, and/or other types of devices.

The memory devices (202) may provide memory resources (e.g., transitory and/or persistent storage) in which a composed information handling system may store data including any type and quantity of information. The memory devices (202) may include any type and quantity of devices for storing data. The devices may include, for example, transitory memory such as random access memory, persistent memory such as enterprise class memory, etc. The memory devices (202) may include other types of devices for providing memory resources without departing from the invention. For example, the storage devices (200) may include controllers (e.g., replication managers), load balancers, and/or other types of devices.

The special purpose devices (204) may provide other types of computing resources (e.g., graphics processing resources, computation acceleration resources, etc.) to composed information handling systems. The special purpose devices (204) may include any type and quantity of devices for providing other types of computing resources. The special purpose devices (204) may include, for example, graphics processing units for providing graphics processing resources, compute accelerators for accelerating corresponding workloads performed by composed information handling systems, application specific integrated circuits (ASICs) for performing other functionalities, digital signal processors for facilitating high speed communications, etc. The special purpose devices (204) may include other types of devices for providing other types of computing resources without departing from the invention.

The system control processors of the information handling systems may mediate presentation of the computing resources provided by the hardware resources (118) to computing resource sets (e.g., as bare metal resources to processors). When doing so, the system control processors may provide a layer of abstraction that enables the hardware resources (118) to be, for example, virtualized, emulated as being compatible with other systems, and/or directly connected to the compute resource sets (e.g., pass through). Consequently, the computing resources of the hardware resources (118) may be finely, or at a macro level, allocated to different composed information handling systems.

Additionally, the system control processors may manage operation of these hardware devices in accordance with one or more models including, for example, data protection models, security models, workload performance availability models, reporting models, etc. For example, the system control processors may cause multiple copies of data to be redundantly stored, to be stored with error correction code, and/or other information usable for data integrity purposes.

The manner of operation of these devices may be transparent to the computing resource sets utilizing these hardware devices for providing computer implemented services. Consequently, even though the resulting composed information handling system control plane may be unaware of the implementation of these models, the composed information handling systems may still operate in accordance with these models thereby providing a unified method of managing the operation of composed information handling systems.

Further, by mediating communications between the hardware resources (118) and compute resource sets, the control resource set may monitor communications between these device, may query the hardware resources (118) to obtain information regarding their operation, and/or may obtain automatically generated telemetry information by the hardware resources (118). Consequently, the control resource set may be able to use the aforementioned information to provide additional information regarding the operation of resource set components.

While the hardware resources (118) have been illustrated and described as including a limited number of specific components, hardware resources in accordance with embodiments of the invention may include additional, fewer, and/or different components without departing from the invention.

As discussed above, information handling systems may include system control processors that may be used to instantiate composed information handling systems. FIG. 3 shows a diagram of a system control processor (298) in accordance with one or more embodiments of the invention. Any of the system control processors included in control resources sets of FIG. 1.2 may be similar to the system control processor (298) illustrated in FIG. 3.

The system control processor (298) may facilitate instantiation, reallocation of resources to/from composed systems, operation of composed information handling systems, and management of information handling systems by facilitating collection and aggregation of operation data of resource set components. By doing so, a system that includes information handling systems may dynamically instantiate and recompose (e.g., add/remove/replace resources) composed information handling systems to provide computer implemented services while ensuring that complete pictures regarding the operation of the composed information handling systems are available (as opposed to a piece meal basis where only a portion of the operation data regarding resource set components hosted by a particular information handling system).

To instantiate and operate composed information handling systems, the system control processor (298) may include a composition manager (300), a telemetry management agent (301), a physical resources manager (302), an emulated resources manager (304), a virtual resources manager (306), an operation manager (308), hardware resource services (310), and storage (312). Each of these components of the system control processor is discussed below.

The composition manager (300) may manage the process of instantiating and operating composed information handling systems. To provide these management services, the composition manager (300) may include functionality to (i) obtain information regarding the hardware components of the information handling system (e.g., obtain telemetry data regarding the information handling system), (ii) provide the obtained information to other entities (e.g., management entities such as system control processor manager (50, FIG. 1.1)), (iii) obtain composition/recomposition requests for composed information handling systems, (iv) based on the composition requests, prepare and present resources as bare metal resources to compute resource sets, (v) setup management services for these allocated resource set components, (vi) instantiate applications in composed information handling systems to cause the composed information handling systems to provide computer implemented services, conform their operation to security models, etc., (vii) add/remove/recompose resources presented to the compute resource sets of composed information handling systems dynamically in accordance with utilization levels of the resources, and/or (viii) coordinate with other system control processors to provide distributed system functionalities and/or transfer performance of applications and/or computer implemented services between composed information handling systems. By providing the above functionalities, a system control processor in accordance with one or more embodiments of the invention may enable distributed resources from any number of information handling systems to be aggregated into a composed information handling system to provide computer implemented services while managing the operation of resource set components allocated to each of these composed information handling systems.

To obtain information regarding the hardware components of the information handling system, the composition manager (300) may inventory the components of the information handling system hosting the system control processor. The inventory may include, for example, the type and model of each hardware component, versions of firmware or other code executing on the hardware components, and/or information regarding hardware components of the information handling system that may be allocated to form composed information handling systems.

The composition manager (300) may obtain composition requests from other entities (e.g., management entities tasked with instantiating composed information handling systems), as pre-loaded instructions present in storage of the system control processor, and/or via other methods. The composition requests may specify, for example, the types and quantities of computing resources to be allocated to a composed information handling system.

In one or more embodiments of the invention, the composition requests specify the computing resource allocations using an intent based model. For example, rather than specifying specific hardware devices (or portions thereof) to be allocated to a particular compute resource set to obtain a composed information handling system, the resource requests may only specify that a composed information handling system is to be instantiated having predetermined characteristics, that a composed information handling system will perform certain workloads or execute certain applications, and/or that the composed information handling system be able to perform one or more predetermined functionalities. In such a scenario, the composition manager may decide how to instantiate the composed information handling system (e.g., which resources to allocate, how to allocate the resources (e.g., virtualization, emulation, redundant workload performance, data integrity models to employ, etc.), to which compute resource set(s) to present corresponding computing resources, etc.).

In one or more embodiments of the invention, the composition requests specify the computing resource allocations using an explicit model. For example, the composition requests may specify (i) the resources to be allocated, (ii) the manner of presentation of those resources (e.g., emulating a particular type of device using a virtualized resource vs. path through directly to a hardware component), and (iii) the compute resource set(s) to which each of the allocated resources are to be presented.

In addition to specifying resource allocations, the composition requests may also specify, for example, applications to be hosted by the composed information handling systems, security models to be employed by the composed information handling systems, communication models to be employed by the composed information handling systems, services to be provided to the composed information handling systems, user/entity access credentials for use of the composed information handling systems, and/or other information usable to place the composed information handling systems into states in which the composed information handling systems provide desired computer implemented services.

To prepare and present resources to compute resource sets based on the composition requests, the system control processors may implement, for example, abstraction, indirection, virtualization, mapping, emulation, and/or other types of services that may be used to present any type of resources as a resource that is capable of bare metal utilization by compute resource sets. To provide these services, the composition manager (300) may invoke the functionality of the physical resources manager (302), the emulated resources manager (304), and/or the virtual resources manager (306).

When presenting the resources to the compute resource sets, the system control processor (298) may present the resources using an emulated data plane. For example, the system control processors (298) may receive bare metal communications (e.g., IO from the processors) and respond in a manner consistent with responses of corresponding bare metal devices (e.g., memory, storages, network interface cards, etc.). When doing so, the system control processor (298) may translate the communications into actions. The actions may be provided to the hardware devices used by the system control processor (298) to present the bare metal resources to the compute resource set(s). In turn, the hardware devices may perform the actions which results in a composed information handling system providing desired computer implemented services.

In some scenarios, multiple system control processors may cooperate to present bare metal resources to a compute resource set. For example, a single information handling system may not include sufficient hardware devices to present a quantity and/or type of resources to a compute resource set as specified by a composition request (e.g., present two storage devices to a compute resource set when a single information handling system only includes a single storage device). In this scenario, a second system control processor of a second information handling system operably connected to the system control processor tasked with presenting the resources to a compute resource set may prepare one of its storage devices for presentation. Once prepared, the second system control processor may communicate with the system control processor to enable the system control processor to present the prepared storage device (i.e., the storage device in the information handling system) to the compute resource set. By doing so, resources from multiple information handling systems may be aggregated to present a desired quantity of resources to compute resource set(s) to form a composed information handling system.

Once resources are allocated to a composed information handling system, the composition manager (300) may then setup management services for them to manage the operation of each resource set component that has been allocated. To do so, the composition manager (300) may invoke the functionality of the telemetry management agent (301) or otherwise notify the telemetry management agent (301) of the presence of these resource set components.

Once notified of the presence of an allocated resource set component, the telemetry management agent (301) may configure the resource set component to send operation data in accordance with a telemetry model to an aggregation point. The telemetry management agent (301) may do so by directly configuring the resource set component or instructing a management entity of a resource set hosting the resource set component to configure the resource set component. For example, the telemetry management agent (301) may specify an operating system executing on a control resource set to configure a processor to send operation data to an aggregation point.

When operating, the telemetry management agent (301) may utilize data in storage (312) including, for example, operation data (316) reflecting the operation of any number of resource set components and a telemetry model repository (318) which may include a telemetry model for a composed information handling system. These data structures are discussed in greater detail below.

By forming composed information handling systems as discussed above, embodiments of the invention may provide a system that is able to effectively utilize distributed resources across a range of devices to provide computer implemented services.

When providing its functionality, the composition manager (300) and/or telemetry management agent (301) may perform all, or a portion, of the methods illustrated in FIGS. 5-6.

While the telemetry management agent (301) is illustrated in FIG. 3 as being part of the system control processor (298), the telemetry management agent (301) may be implemented as a separate device from the system control processor (298) without departing from the invention. For example, the telemetry management agent (301) may be implemented as a service hosted by any number of devices including, in part, the composed information handling system to which the system control processor (298) is allocated).

The physical resources manager (302) may manage presentation of resources to compute resource sets. For example, the physical resources manager (302) may generate, for example, translation tables that specify actions to be performed in response to bare metal communications obtained from compute resource sets. The translation tables may be used to take action in response to communications from compute resource sets.

The physical resources manager (302) may generate the translation tables based on the components of the compute resource sets, allocations or other types of commands/communications obtained from the compute resource sets, and the resources of the information handling system(s) allocated to service the compute resource set. For example, when a compute resource set is presented with a bare metal resource, it may go through a discovery process to prepare the bare metal resource for use. As the discovery process proceeds, the compute resource set may send commands/communications to the bare metal resource to, for example, discover its address range. The physical resources manager (302) may monitor this process, respond appropriately, and generate the translation table based on these commands and the resources available to service these bare metal commands/communications (e.g., to obtain address translation tables, emulation tables, etc.).

For example, consider a scenario where a virtualized disk is allocated to service bare metal storage commands from a compute resource set. In such a scenario, the physical resources manager (302) may generate a translation table that translates physical write from the compute resource set to virtualized writes corresponding to the virtualized disk. Consequently, the virtualized disk may be used by the system control processor (298) to present bare metal resources to the compute resource set.

The emulated resources manager (304) may generate emulation tables that enable resources that would otherwise be incompatible with a compute resource set to be compatible with the compute resource set. Different types of hardware devices of a compute resource set may be compatible with different types of hardware devices. Consequently, resources allocated to provide bare metal resources may not necessarily be compatible with the hardware devices of a compute resource set. The emulated resources manager (304) may generate emulation tables that map bare metal communications obtained from a compute resource set to actions that are compatible with resources allocated to provide bare metal resources to the compute resource sets.

The virtual resources manager (306) may manage virtualized resources that may be allocated to provide bare metal resources to compute resource sets. For example, the virtual resources manager (306) may include hypervisor functionality to virtualized hardware resources and allocate portions of the virtualized resources for use in providing bare metal resources.

While the physical resources manager (302), emulated resources manager (304), and virtual resources manager (306) have been described as generating tables, these components of the system control processor may generate other types of data structures or utilize different management models to provide their respective functionalities without departing from the invention.

The functionalities of the physical resources manager (302), emulated resources manager (304), and virtual resources manager (306) may be utilized in isolation and/or combination to provide bare metal resources to compute resource sets. By doing so, the system control processor (298) may address compatibility issues, sizing issues to match available resources to those that are to be allocated, and/or other issues to enable bare metal resources to be presented to compute resource sets.

When providing bare metal resources, the composition manager (300) may invoke the functionality of the physical resources manager (302), emulated resources manager (304), and virtual resources manager (306). Consequently, resources may be presented as bare metal resources via pass-through (i.e., forwarding IO from compute resource sets to hardware devices), bare metal resource addressing of virtualized resources, and/or as emulated resources compatible with the hardware components of the compute resource set.

The functionality of the physical resources manager (302), emulated resources manager (304), and virtual resources manager (306) may be invoked using any communication model including, for example, message passing, state sharing, memory sharing, etc.

The operation manager (308) may manage the general operation of the system control processor (298). For example, the operation manager (308) may operate as an operating system or other entity that manages the resources of the system control processor (298). The composition manager (300), telemetry management agent (301), physical resources manager (302), emulated resources manager (304), virtual resources manager (306), and/or other entities hosted by the system control processor (298) may call or otherwise utilize the operation manager (308) to obtain appropriate resources (e.g., processing resources, memory resources, storage, communications, etc.) to provide their functionalities.

The hardware resource services (310) may facilitate use of the hardware components of any number of hardware resource sets (e.g., 110, FIG. 1.2). For example, the hardware resource services (310) may include driver functionality to appropriately communicate with the hardware devices of hardware resource sets. The hardware resource services (310) may be invoked by, for example, the operation manager (308).

When providing their functionalities, any of the aforementioned components of the system control processor (298) may perform all, or a portion, of the methods illustrated in FIGS. 5-6.

The system control processor (298) may be implemented using computing devices. The computing devices may be, for example, an embedded computing device such as a system on a chip, a processing device operably coupled to memory and storage, or another type of computing device. The computing device may include one or more processors, memory (e.g., random access memory), and/or persistent storage (e.g., disk drives, solid state drives, etc.). The persistent storage may store computer instructions, e.g., computer code, that (when executed by the processor(s) of the computing device) cause the computing device to perform the functions of the system control processor (298) described in this application and/or all, or a portion, of the methods illustrated in FIGS. 5-6. The system control processor (298) may be implemented using other types of computing devices without departing from the invention. For additional details regarding computing devices, refer to FIG. 8.

In one or more embodiments of the invention, the system control processor (298) is implemented as an on-board device. For example, the system control processor (298) may be implemented using a chip including circuitry disposed on a circuit card. The circuit card may also host the compute resource sets and/or hardware resource sets managed by the system control processor (298).

In one or more embodiments of the invention, any of the composition manager (300), telemetry management agent (301), physical resources manager (302), emulated resources manager (304), virtual resources manager (306), operation manager (308), and/or hardware resource services (310) are implemented using a hardware device including circuitry. The hardware device may be, for example, a digital signal processor, a field programmable gate array, or an application specific integrated circuit. The circuitry may be adapted to cause the hardware device to perform the functionality of the composition manager (300), telemetry management agent (301), physical resources manager (302), emulated resources manager (304), virtual resources manager (306), operation manager (308), and/or hardware resource services (310). The composition manager (300), telemetry management agent (301), physical resources manager (302), emulated resources manager (304), virtual resources manager (306), operation manager (308), and/or hardware resource services (310) may be implemented using other types of hardware devices without departing from the invention.

In one or more embodiments of the invention, any of the composition manager (300), telemetry management agent (301), physical resources manager (302), emulated resources manager (304), virtual resources manager (306), operation manager (308), and/or hardware resource services (310) are implemented using a processor adapted to execute computing code stored on a persistent storage (e.g., as part of the system control processor (298) or operably connected to the system control processor (298) thereby enabling processors of the system control processor (298) to obtain and execute the computing code) that when executed by the processor performs the functionality of the composition manager (300), telemetry management agent (301), physical resources manager (302), emulated resources manager (304), virtual resources manager (306), operation manager (308), and/or hardware resource services (310). The processor may be a hardware processor including circuitry such as, for example, a central processing unit or a microcontroller. The processor may be other types of hardware devices for processing digital information without departing from the invention.

As used herein, an entity that is programmed to perform a function (e.g., step, action, etc.) refers to one or more hardware devices (e.g., processors, digital signal processors, field programmable gate arrays, application specific integrated circuits, etc.) that provide the function. The hardware devices may be programmed to do so by, for example, being able to execute computer instructions (e.g., computer code) that cause the hardware devices to provide the function. In another example, the hardware device may be programmed to do so by having circuitry that has been adapted (e.g., modified) to perform the function. An entity that is programmed to perform a function does not include computer instructions in isolation from any hardware devices. Computer instructions may be used to program a hardware device that, when programmed, provides the function.

In one or more embodiments disclosed herein, the storage (312) is implemented using physical devices that provide data storage services (e.g., storing data and providing copies of previously stored data). The devices that provide data storage services may include hardware devices and/or logical devices. For example, storage (312) may include any quantity and/or combination of memory devices (i.e., volatile storage), long term storage devices (i.e., persistent storage), other types of hardware devices that may provide short term and/or long term data storage services, and/or logical storage devices (e.g., virtual persistent storage/virtual volatile storage).

For example, storage (312) may include a memory device (e.g., a dual in line memory device) in which data is stored and from which copies of previously stored data are provided. In another example, storage (312) may include a persistent storage device (e.g., a solid-state disk drive) in which data is stored and from which copies of previously stored data is provided. In a still further example, storage (312) may include (i) a memory device (e.g., a dual in line memory device) in which data is stored and from which copies of previously stored data are provided and (ii) a persistent storage device that stores a copy of the data stored in the memory device (e.g., to provide a copy of the data in the event that power loss or other issues with the memory device that may impact its ability to maintain the copy of the data cause the memory device to lose the data).

The storage (312) may also be implemented using logical storage. A logical storage (e.g., virtual disk) may be implemented using one or more physical storage devices whose storage resources (all, or a portion) are allocated for use using a software layer. Thus, a logical storage may include both physical storage devices and an entity executing on a processor or other hardware device that allocates the storage resources of the physical storage devices.

The storage (312) may store data structures including, for example, composed information handling system data (314), operation data (316), and a telemetry model repository (318). Each of these data structures is discussed below.

The composed information handling system data (314) may be implemented using one or more data structures that includes information regarding composed information handling systems. For example, the composed information handling system data (314) may specify identifiers of composed information handling systems and resources that have been allocated to the composed information handling systems.

The composed information handling system data (314) may also include information regarding the operation of the composed information handling systems. The information may include, for example, workload performance data, resource utilization rates over time, and/or other information that may be utilized to manage the operation of the composed information handling systems.

The composed information handling system data (314) may further include information regarding management models employed by system control processors. For example, the composed information handling system data (314) may include information regarding duplicative data stored for data integrity purposes, redundantly performed workloads to meet high availability service requirements, encryption schemes utilized to prevent unauthorized access of data, etc.

The composed information handling system data (314) may be maintained by, for example, the composition manager (300). For example, the composition manager may add, remove, and/or modify information included in the composed information handling system data (314) to cause the information included in the composed information handling system data (314) to reflect the state of the composed information handling systems.

The data structures of the composed information handling system data (314) may be implemented using, for example, lists, tables, unstructured data, databases, etc. While illustrated in FIG. 3 as being stored locally, the composed information handling system data (314) may be stored remotely and may be distributed across any number of devices without departing from the invention.

The operation data (316) may be implemented using one or more data structures that include information regarding the operation of any number of resource set components. The operation data (316) may include telemetry data associated with any number of these resource set components (e.g., when the system control processor (298) is operating as a collector or intermediary to provide operation data to an aggregation point or as another entity tasked with gathering data that is not self-reported by the resource set components). The telemetry data may include, for example, information derived from communications from these components that traversed through the system control processor (298), information from the resource set components themselves such as health monitoring data, and/or information collected from other sources (e.g., other system control processors monitoring other communications).

The data structures of the operation data (316) may be implemented using, for example, lists, tables, unstructured data, databases, etc. While illustrated in FIG. 3 as being stored locally, the operation data (316) may be stored remotely and may be distributed across any number of devices without departing from the invention.

The operation data (316) may be maintained by, for example, the telemetry management agent (301). For example, the telemetry management agent (301) may add, remove, and/or modify information included in the operation data (316) to cause the information included in the operation data (316) to reflect operation data associated with any number of resource set components.

The telemetry model repository (318) may be implemented using one or more data structures that includes information regarding telemetry models. The telemetry models may have been generated by a composed system manager (e.g., 25, FIG. 1.1).

For example, the telemetry model repository (318) may specify information regarding telemetry models such as which, where, how, and what type of operation data of resource set components is to be collected. The telemetry management agent (301) may use the information regarding the telemetry models to configure the resource set components. Because a system control processor may be part of multiple composed information handling system, the telemetry model repository (318) may include information regarding multiple telemetry models corresponding to the composed information handling systems. Consequently, when configuring the resource set components, different resource set components may send operation data to different aggregation points (or the same aggregation point) if specified by the telemetry models.

The telemetry model repository (318) may be organized as a table. Each row may include one or more information regarding the configuration of respective resource set components. Each row may include any quantity of configuration information specified at any level of granularity (e.g., a row may correspond to configuration information for multiple components) without departing from the invention.

The telemetry model repository (318) may be maintained by, for example, the telemetry management agent (301). For example, the telemetry management agent (301) may add, remove, and/or modify information included in the telemetry model repository (318) in response to instructions from or models provided a composed system manager (e.g., 25, FIG. 1.1).

The data structures of the telemetry model repository (318) may be implemented using, for example, lists, tables, unstructured data, databases, etc. While illustrated in FIG. 3 as being stored locally, the telemetry model repository (318) may be stored remotely and may be distributed across any number of devices without departing from the invention.

While the storage (312) has been illustrated and described as including a limited number and type of data, a storage in accordance with embodiments of the invention may store additional, less, and/or different data without departing from the invention.

While the system control processor (298) has been illustrated and described as including a limited number of specific components, a system control processor in accordance with embodiments of the invention may include additional, fewer, and/or different components without departing from the invention.

As discussed above, a composed system manager may coordinate collection, aggregation, transformation, and utilization of operation data for composed information handling systems. FIG. 4 shows a diagram of the composed system manager (25) in accordance with one or more embodiments of the invention.

The composed system manager (25) may manage the process of collecting, transforming, and using operation data to manage the operation of composed information handling systems. To do so, the composed system manager (25) may include a telemetry manager (402) and storage (410). Each of these components is discussed below.

The telemetry manager (402) may provide telemetry data management services. Telemetry data management services may include (i) identifying composed information handling systems (e.g., by obtaining information regarding newly instantiated composed information handling systems from a system control processor manager and updating a composed system map (412) based on the information), (ii) identifying resource set components of the composed information handling systems using the composed system map (412), (iii) generating telemetry models (414) for the composed information handling systems based on the identified resource set components, (iv) distributing information regarding and/or the telemetry models (414) to control resource sets and/or other entities (e.g., management entities of other types of resource sets), (v) instructing the control resource sets and/or other entities to configure the resource set components in accordance with the telemetry models (414), (vi) generating standardized telemetry packages (416) based on operation data aggregated from resource set components, and (vii) using the standardized telemetry packages (416) to manage the operation of the composed information handling systems. By doing so, the telemetry manager (402) may facilitate management of composed systems.

For example, when a new composed information handling system is instantiated, it may include any number of resource set components distributed across any number of information handling systems. The telemetry manager (402) may generate a telemetry model for the newly instantiated composed information handling system. The telemetry model may specify (i) the operation data to be collected, (ii) where to aggregate the operation data, and (iii) how to transform the aggregated operation data to obtain a standardized telemetry package for the composed information handling system. A standardized telemetry package may be a data structure that represents the composed information handling system as though it were a single device rather than a distributed device.

For example, the telemetry manager (402) may remove references to multiple information handling systems, may restructure the collected data, and/or more perform other transformation operations to place the aggregated operation data into a standardized format compatible with applications that presume telemetry data is from a single source. By doing so, existing applications and entities that provide management services (e.g., remediate the operation of devices or take other types of actions based on telemetry data) may utilize the standardized telemetry packages (416). Consequently, the composed system manager (25) may distribute the standardized telemetry packages (416) to any number of applications and/or other types of management entities to manage the operation of the composed information handling systems. In turn, these applications/entities may take action to modify the operation of the composed information handling system if warranted based on the content of the standardized telemetry packages (416).

In one or more embodiments of the invention, the telemetry manager (402) is implemented using a hardware device including circuitry. The hardware device may be, for example, a digital signal processor, a field programmable gate array, or an application specific integrated circuit. The circuitry may be adapted to cause the hardware device to perform the functionality of the telemetry manager (402). The telemetry manager (402) may be implemented using other types of hardware devices without departing from the invention.

In one or more embodiments of the invention, the telemetry manager (402) is implemented using a processor adapted to execute computing code stored on a persistent storage that when executed by the processor performs the functionality of the telemetry manager (402). The processor may be a hardware processor including circuitry such as, for example, a central processing unit or a microcontroller. The processor may be other types of hardware devices for processing digital information without departing from the invention.

When providing its functionality, the telemetry manager (402) may perform all, or a portion, of the methods illustrated in FIGS. 5-6.

In one or more embodiments disclosed herein, the storage (410) is implemented using physical devices that provide data storage services (e.g., storing data and providing copies of previously stored data). The devices that provide data storage services may include hardware devices and/or logical devices. For example, storage (410) may include any quantity and/or combination of memory devices (i.e., volatile storage), long term storage devices (i.e., persistent storage), other types of hardware devices that may provide short term and/or long term data storage services, and/or logical storage devices (e.g., virtual persistent storage/virtual volatile storage).

For example, storage (410) may include a memory device (e.g., a dual in-line memory device) in which data is stored and from which copies of previously stored data are provided. In another example, storage (410) may include a persistent storage device (e.g., a solid-state disk drive) in which data is stored and from which copies of previously stored data is provided. In a still further example, storage (410) may include (i) a memory device (e.g., a dual in line memory device) in which data is stored and from which copies of previously stored data are provided and (ii) a persistent storage device that stores a copy of the data stored in the memory device (e.g., to provide a copy of the data in the event that power loss or other issues with the memory device that may impact its ability to maintain the copy of the data cause the memory device to lose the data).

The storage (410) may also be implemented using logical storage. A logical storage (e.g., virtual disk) may be implemented using one or more physical storage devices whose storage resources (all, or a portion) are allocated for use using a software layer. Thus, a logical storage may include both physical storage devices and an entity executing on a processor or other hardware device that allocates the storage resources of the physical storage devices.

The storage (410) may store data structures including, for example, the composed system map (412), telemetry models (414), and standardized telemetry packages (416). These data structures may be maintained by, for example, the telemetry manager (402). For example, the telemetry manager (402) may add, remove, and/or modify information included in these data structures to cause the information included in these data structures.

Any of these data structures may be implemented using any combination and quantity of, for example, lists, tables, unstructured data, databases, etc. While illustrated in FIG. 4 as being stored locally, any of these data structures may be stored remotely and may be distributed across any number of devices without departing from the invention.

While the storage (410) has been illustrated and described as including a limited number and type of data, a storage in accordance with embodiments of the invention may store additional, less, and/or different data without departing from the invention.

While the composed system manager (25) has been illustrated and described as including a limited number of specific components, a composed system manager in accordance with embodiments of the invention may include additional, fewer, and/or different components than those illustrated in FIG. 4 without departing from the invention.

As discussed above, the system of FIG. 1.1 may provide computer implemented services using composed information handling systems. FIG. 5 shows methods that may be performed by components of the system of FIG. 1.1 to manage composed information handling systems.

FIG. 5 shows a flowchart of a method in accordance with one or more embodiments of the invention. The method depicted in FIG. 5 may be performed to instantiate composed information handling systems in accordance with one or more embodiments of the invention. The method shown in FIG. 5 may be performed by, for example, a composed system manager (e.g., 25, FIG. 1.1). Other components of the system in FIG. 1.1 may perform all, or a portion, of the method of FIG. 5 without departing from the invention.

While FIG. 5 is illustrated as a series of steps, any of the steps may be omitted, performed in a different order, additional steps may be included, and/or any or all of the steps may be performed in a parallel and/or partially overlapping manner without departing from the invention.

In step 500, a determination that a composed information handling system has been instantiated is made. The determination may be made based on information obtained from a system control processor manager. For example, the system control processor manager may notify the composed system manager whenever an instantiation or recomposition occurs. The system control processor manager may provide information regarding which resource set components from any number of information handling system were allocated during the instantiation/recomposition. The determination may be made via other methods without departing from the invention.

For example, the composed system manager may monitor network communications or other sources of information that may indicate the presence of a new and/or recomposed composed information handling system.

In step 502, resource set components allocated to the composed information handling system are identified. The resource set components may be identified based on information obtained in Step 500. As noted above, the composed information handling system may receive notifications that indicate the allocated resource set components and/or may actively monitor for instantiated/recomposed information handling systems.

In step 504, a telemetry model is generated based on the resource set components identified in step 502. The telemetry model may include (i) information regarding which components should provide operation data, (ii) the type, frequency of providing, content, and/or other information regarding the operation data that is to be provided, (iii) where the operation data is to be aggregated (e.g., an aggregation point such as an information handling system, composed information handling system, composed system manager, or other entity), (iv) information regarding how to transform the aggregated operation information into a standardized telemetry package (e.g., one or more actions to be performed to obtain the standardized telemetry package), and/or (v) information regarding the use of the obtained standardized telemetry package (e.g., to which entities the standardized telemetry packages should be provided, how to use the standardized telemetry package to modify the operation of the composed information handling systems, etc.).

The telemetry model may be stored as part of a repository. Information regarding the telemetry model and/or copies of the telemetry model may be subsequently distributed, as will be discussed with respect to step 506.

In step 506, resource set components are configured based on the telemetry model to aggregate telemetry data. The resource set components may be configured to modify the operation of the resource set components to send operation, directly or indirectly (e.g., sent to another component to be relayed to an aggregation point), to an aggregation point. The resource set components my be configured using any method (e.g., modifying configuration files, invoking application programming interfaces, etc.) without departing from the invention.

The resource set components configured in step 506 may be specified by the telemetry model. The resource set components may include all, or a portion, of the resource set components identified in step 502. For example, the resource set components may not include all of the resource set components identified in step 502 when some of the identified resource set components may provide undesirable operation data (e.g., duplicative data, data that is not helpful in managing the operation of the composed information handling system, etc.).

The resource set components may be configured directly (e.g., by sending instructions to the resource set components) or indirectly (e.g., by requesting that another entity such as a system control processor perform actions to configure resource set components). The configuration of each resource set component may be specified by the telemetry model. The resource set components configured in step 506 may include resource set components of the composed information handling system and/or other composed information handling systems (and/or resource set components that have not been allocated to a composed information handling system). For example, components that are not allocated and/or not allocated to the composed information handling system may be configured to provide operation information regarding a resource set components of the composed information handing system thereby enabling operation information that is not self-reported to be obtained.

The method may end following step 506.

Using the method illustrated in FIG. 5, operation information for resource set components of a composed information handling system may be aggregated. By doing so, an overall picture regarding the operation of the composed information handling system may be obtained.

In one or more embodiments of the invention, following step 506, a composed system information manager may (i) monitor the aggregated operation data, (ii) use pattern matching or other methods of identifying actions to be taken based on the aggregated operations data, and (iii) performs the actions. The actions may modify the operation of one or more resource set components thereby modifying the operation of the composed information handling system. By modifying the operation of the composed information handling system, the composed information handling system may operate in a more desirable manner by, for example, being less susceptible to operational error, be more likely to complete tasks, and may otherwise provide a more desirable user experience by reducing the likelihood of the occurrence of phantom slow downs due to undesirable operation of one or more resource set components.

Turning to FIG. 6, the resource set components may begin to generate and aggregate operation data in an aggregation point. The method illustrated in FIG. 6 may be performed to utilize the aggregated operation data.

FIG. 6 shows a flowchart of a method in accordance with one or more embodiments of the invention. The method depicted in FIG. 6 may be performed to obtain a standardized telemetry package for a composed information handling system in accordance with one or more embodiments of the invention. The method shown in FIG. 6 may be performed by, for example, an aggregation point such as a composed system manager (e.g., 25, FIG. 1.1). Other components of the system in FIG. 1.1 may perform all, or a portion, of the method of FIG. 6 without departing from the invention.

While FIG. 6 is illustrated as a series of steps, any of the steps may be omitted, performed in a different order, additional steps may be included, and/or any or all of the steps may be performed in a parallel and/or partially overlapping manner without departing from the invention.

In step 600, operation data (e.g., telemetry data) for resource set components associated with the composed information handling system is obtained. The telemetry data may be obtained in accordance with any type of communication model (e.g., push-pull, publish-subscribe, request-provide, etc.) without departing from the invention.

As noted above, the resource set components may be configured to provide the operation data. The operation data may include any type and quantity of data regarding the operation of the resource set components. The operation data may be provided directly to an aggregation point or through a collector such as a system control processor or other entity (e.g., if large quantities of operation data are being collected any number of entities may be tasked with collecting operation data from respective subsets of the resource set components of a composed information handling system). The collectors may operate as intermediate aggregation points which may then provide the intermediate collection of aggregated operation data to an aggregation point. The collectors may be instantiated as part of the process of configuring the resource set components.

The operation data may include self-reported data and independently reported data (e.g., by another component that monitors the operation of a resource set component such as a system control processor). In some embodiments of the invention, self-reported data and independently reported data that should be duplicative of each other may be collected to verify that the operation data is being accurately collected (e.g., if a difference is identified then either the self-reported or independently reported operation data may be inaccurate).

In step 602, the obtained operation data is aggregated. The obtained operation may be aggregated by, for example, adding the different portion of operation data to one or more data structures such as a table, list, database, etc. or by storing the operation data in a predetermined location (e.g., a directory).

In step 604, a standardized telemetry package for the composed information handling system is generating using the obtained operation data. The standardized telemetry package may be obtained by generating a new data structure or modifying the aggregated operation data based on information included in the telemetry model for the composed information handling system.

For example, the telemetry model may specify any number of actions that may be performed to obtain the standardized telemetry package. The actions may include (i) conforming the organization of the operation data to a predetermined format, (ii) removing identifiers or other information indicating that different portions of the telemetry data were obtained from different information handling systems, (iii) adding information that indicates that the operation information was obtained from a single device, (vi) synthesizing new data based on portion of the obtained operation data, and/or (vi) other actions that may result in the formation of a standardized telemetry package that may be utilized by existing applications and entities that may presume that operation data will be presented in a predetermined format, include predetermined content, and/or will have other predetermined characteristics.

The method may end following step 604.

Using the method illustrated in FIG. 6, a standardized telemetry package for the composed information handling system may be obtained. By obtaining the standardized telemetry package, the composed information handling system may be managed by modifying its operation based on the contents of the standardized telemetry package. By conforming the structure, content, and/or other characteristics of the standardized telemetry package to that which would be expected by existing applications, the standardized telemetry package may be used to manage composed information handling system using existing systems, tools, and methods without requiring further development. Consequently, composed information handling systems may be integrated with existing systems and managed using existing tools thereby removing barriers to entry and adoption of composed information handling systems.

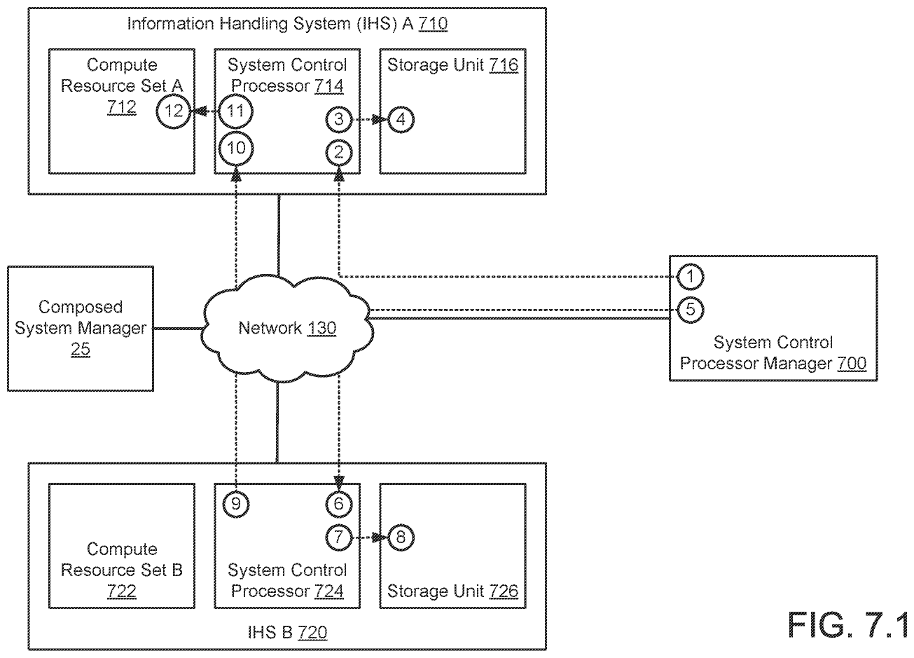

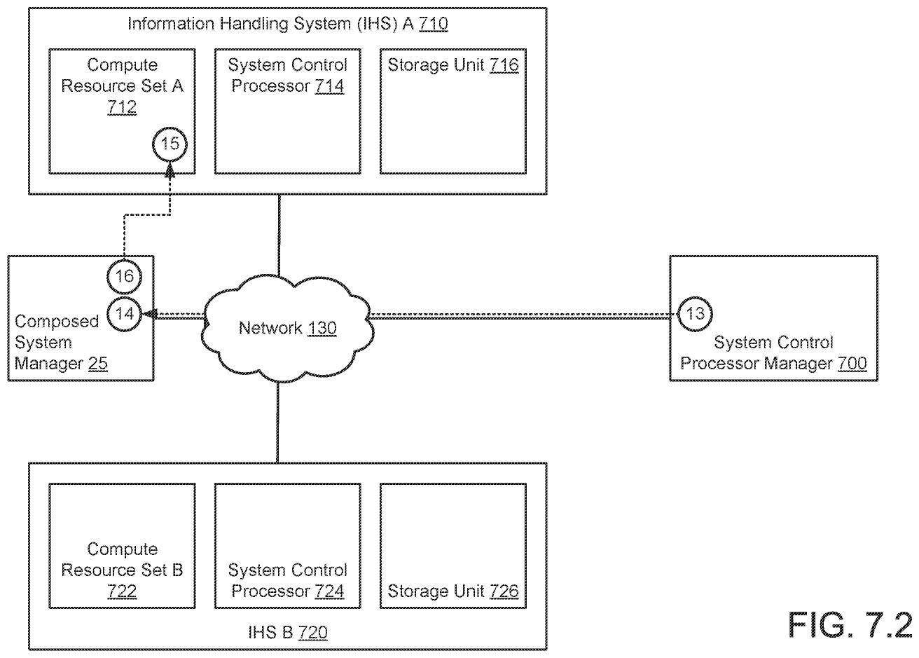

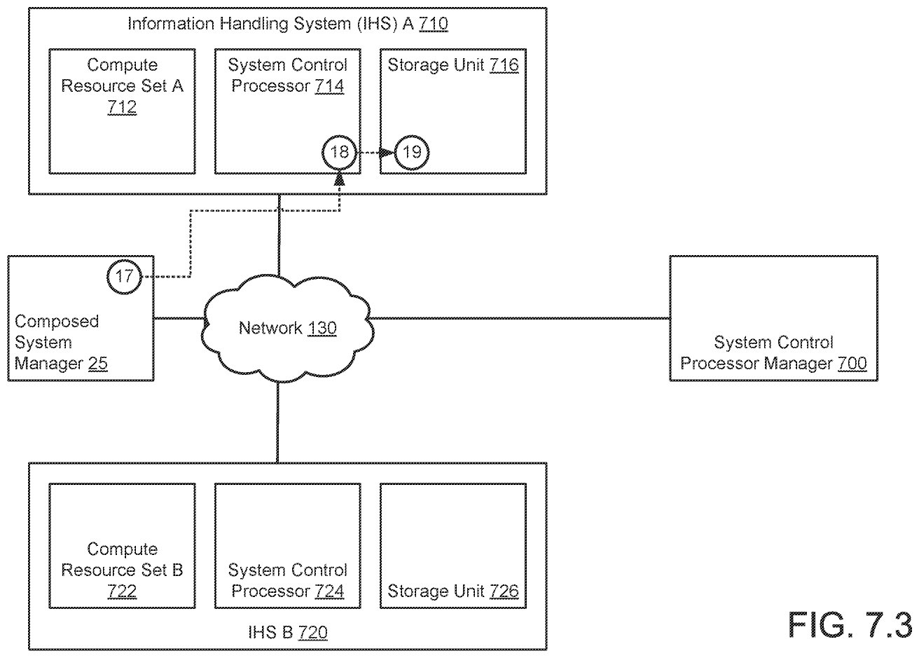

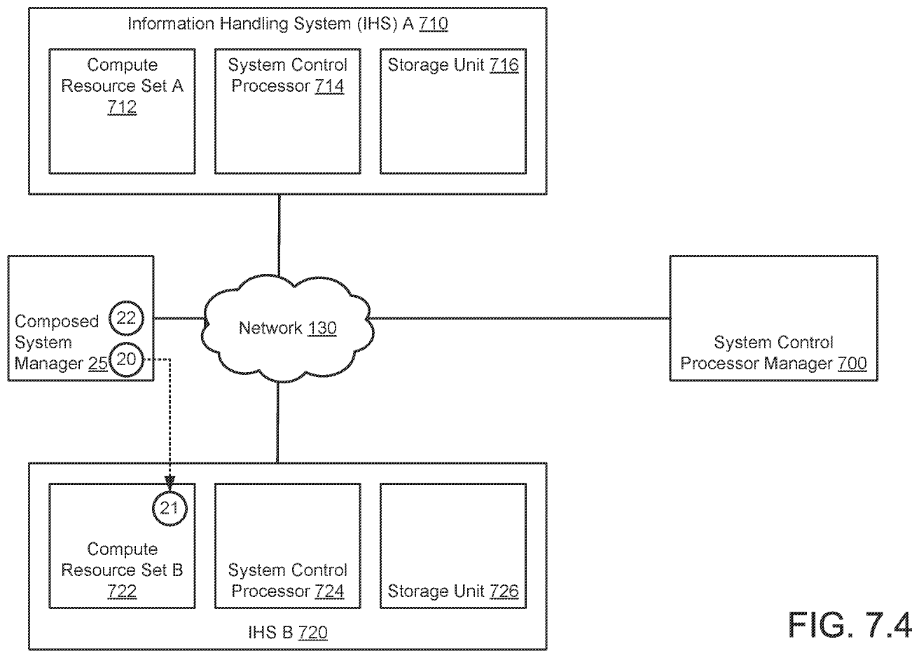

To further clarify embodiments of the invention, a non-limiting example is provided in FIGS. 7.1-7.4. These figures illustrate a system similar to that illustrated in FIG. 1.1. Actions performed by components of the system are illustrated by numbered, circular boxes interconnected, in part, using dashed lines terminating in arrows. For the sake of brevity, only a limited number of components of the system of FIG. 1.1 is illustrated in FIGS. 7.1-7.4.

### Example

Consider a scenario as illustrated in FIG. 7.1 in which a system control processor manager (700) is instantiating a composed information handling system using two information handling systems (710, 720). To instantiate the composed information handling system, the system control processor manager (700), at step 1, decides that compute resource set A (712), storage unit (716), and storage unit (726) should be allocated to the composed information handling system.

At step 2, the system control processor manager (700) generates and sends a composition request to the system control processor (714) of the information handling system A (710).

In response, at step 3, the system control processor (714) sets up management services for the storage unit (716). At step 4, the system control processor (714) allocates the managed storage resources of the storage unit (716) to the composed information handling system and updates corresponding managed data structures to reflect this allocation.

At step 5, the system control processor manager (700) generates and sends a second composition request to the system control processor (724) of the information handling system B (720). In response, at step 6, the system control processor (724) identifies that it will work with the system control processor (714) to allocate the storage resources of the storage unit (726) to the composed information handling system (e.g., without allocating the compute resource set B (722)).

At step 7, the system control processor (724) sets up management services for the storage unit (726). At step 8, the system control processor (724) allocates the storage resources of the storage unit (726) to the composed information handling system and updates corresponding managed data structures to reflect this allocation.

At step 9, the system control processor (724) establishes a connection with the system control processor (714) via network (130). Once setup, the system control processor (724) notifies, at step 10, the system control processor (714) of the allocated storage resources of the storage unit (726).

In step 11, the system control processor (714) updates its maintained data structures based on the storage resources provided by storage unit (726). At step 12, the system control processor (714) presents, as bare metal resources, the storage resources from both the storage unit (716) and storage unit (726). Subsequently, the compute resource set A (712) discovers the resources and begins to use them as bare metal resources.

At this point, a composed information handling system has been formed that includes three resource set components including processors of the compute resource set A (712), storage devices of storage unit (716), and storage devices of storage unit (726).

Turning to FIG. 7.2, at step 13, the system control processor manager (700) notifies the composed system manager (25) of the newly instantiated composed information handling system and its corresponding resource set components. Based on the resource set components, the composed system manager (25), at step 14, generates a telemetry model for the composed system. Using the telemetry mode, at step 16, the composed system manager (25) sends a configuration request to the processors of the compute resource set A (712) indicating that they are to provide operation data to the composed system manager (25).

In response to receiving the configuration request, the processors of the compute resource set A (712), at step 15, modify their configurations to send operation data to the composed system manager (25).

At this point, the processors of the compute resource set A (712) will automatically generate and provide operation data including, for example, health information, operational state information, and other types of information to the composed system manager (25).

Turning to FIG. 7.3, at step 17, the composed system manager (25) generates a second configuration request for the storage devices of the storage unit (716). The second configuration request is sent to the system control processor (714) which, in step 18, configures the storage units (716) to send operation data to it which is then relayed to the composed system manager (25). Consequently, at step 19, the storage devices of the storage unit (716) begin generating and providing operation data to the system control processor (714).

At this point, both the processors of compute resource set A (712) and storage devices of storage unit (716) are configured to provide operation data to composed system manager (25).

Turning to FIG. 7.4, at step 20, the composed system manager (25) generates a third configuration request for the processors of compute resource set B (722). The third configuration request is sent to compute resource set B (722). In response to the third configuration request, at step 21, configure themselves to send operation data to the composed system manager (25).

At this point, all of the resource set components of the composed information handling system begin sending operation data to the composed system manager (25).

At step 22, the composed system manager (25) aggregates the operation data and generates, using the aggregated operation data and the telemetry model for the composed information handling system, a standardized telemetry package.

### End of Example

Thus, as illustrated in FIGS. 7.1-7.4, embodiments of the invention may provide a system that aggregates operation data from any number of components a composed information handling system. By doing so, the overall operation of the composed information handling system may be monitored and information regarding its operation may be made available in a standardized format.

Consequently, management entities tasked with managing the operation of the composed information handling system and other types of devices may not need to be adapted or otherwise modified to manage the composed information handling system. For example, the management entities may monitor the content of the standardized telemetry package and, based on the content, perform one or more actions to modify the operation of resource set components of the composed information handling system. The actions may include, for example, resetting components, modifying the configuration of components, initiating additional monitoring, disabling components, moving workloads between components, notifying administrators of potential problems, etc. By doing so, the composed information handling system may be more likely to operate in a desired manner and/or may enable potential problems regarding the operation of the system to be proactively remediated before they significantly impair the operation (e.g., proactively prevent failure) of the composed information handling system.

As discussed above, embodiments of the invention may be implemented using computing devices. FIG. 8 shows a diagram of a computing device in accordance with one or more embodiments of the invention. The computing device (800) may include one or more computer processors (802), non-persistent storage (804) (e.g., volatile memory, such as random access memory (RAM), cache memory), persistent storage (806) (e.g., a hard disk, an optical drive such as a compact disk (CD) drive or digital versatile disk (DVD) drive, a flash memory, etc.), a communication interface (812) (e.g., Bluetooth interface, infrared interface, network interface, optical interface, etc.), input devices (810), output devices (808), and numerous other elements (not shown) and functionalities. Each of these components is described below.

In one embodiment of the invention, the computer processor(s) (802) may be an integrated circuit for processing instructions. For example, the computer processor(s) may be one or more cores or micro-cores of a processor. The computing device (800) may also include one or more input devices (810), such as a touchscreen, keyboard, mouse, microphone, touchpad, electronic pen, or any other type of input device. Further, the communication interface (812) may include an integrated circuit for connecting the computing device (800) to a network (not shown) (e.g., a local area network (LAN), a wide area network (WAN) such as the Internet, mobile network, or any other type of network) and/or to another device, such as another computing device.

In one embodiment of the invention, the computing device (800) may include one or more output devices (808), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (802), non-persistent storage (804), and persistent storage (806). Many different types of computing devices exist, and the aforementioned input and output device(s) may take other forms.

Embodiments of the invention may provide a system and method for providing computer implemented services using information handling systems. Specifically, embodiments of the invention may provide information handling systems that may be composed into composed systems. These composed systems may include resource set components from any number of information handling systems. When instantiated and/or reconfigured, the resource set components allocated to a composed system may be configured to aggregate operation data at an aggregation point. By doing so, an overall operational state of a composed system may be obtained. The overall operation state may be used to identify remediation actions that can be performed to improve the operation of the composed system.

Thus, embodiments of the invention may address the problem of managing the operation of components across a distributed system.

The problems discussed above should be understood as being examples of problems solved by embodiments of the invention and the invention should not be limited to solving the same/similar problems. The disclosed invention is broadly applicable to address a range of problems beyond those discussed herein.

One or more embodiments of the invention may be implemented using instructions executed by one or more processors of a computing device. Further, such instructions may correspond to computer readable instructions that are stored on one or more non-transitory computer readable mediums.

While the invention has been described above with respect to a limited number of embodiments, those skilled in the art, having the benefit of this disclosure, will appreciate that other embodiments can be devised which do not depart from the scope of the invention. Accordingly, the scope of the invention should be limited only by the attached claims.

What is claimed is:

1. A composed system manager for managing operation of composed information handling systems, comprising:
storage for storing telemetry models for the composed information handling systems; and
a telemetry manager programmed to:
make a determination that a composed information handling system of the composed information handling systems has been instantiated;
in response to the determination, identify resource set components allocated to the composed information handling system;
generate a telemetry model of the telemetry models for the composed information handling system based on the resource set components; and
configure the resource set components based on the telemetry model to aggregate operation data generated by the resource set components.

2. The composed system manager of claim 1, wherein the resource set components comprise:
a first resource set component hosted by a first information handling system; and
a second resource set component hosted by a second information handling system.

3. The composed system manager of claim 2, wherein the first information handling system and the second information handling system are different physical devices.

4. The composed system manager of claim 2, wherein configuring the resource set components comprises programming the first resource set component to send first operation data to an aggregation point.

5. The composed system manager of claim 4, wherein configuring the resource set components further comprises programming the second resource set component to send second operation data to the aggregation point.

6. The composed system manager of claim 5, wherein the first resource set component sends the first operation data to the aggregation point by providing the first operation data to a first system control processor hosted by the first information handling system.

7. The composed system manager of claim 6, wherein the second resource set component sends the second operation data to the aggregation point by providing the second operation data to a second system control processor hosted by the second information handling system.

8. The composed system manager of claim 1, wherein the telemetry manager is further programmed to:
establish an aggregation point for the operation data;
configure the aggregation point to generate, using the aggregated operation data and the telemetry model, a standardized telemetry package for the composed information handling system.

9. The composed system manager of claim 8, wherein the standardized telemetry package comprises data in a format that would be generated by a telemetry generation entity hosted by an information handling system that hosts all of the resource set components.

10. The composed system manager of claim 9, wherein the standardized telemetry package is generated by, at least in part, replacing disparate source information associated with different portion of the operation data with a synthetic common source, wherein the standardized telemetry package indicates that all of the aggregated operation data was obtained from a single bare metal device.

11. A method for managing operation of composed information handling systems, comprising:
making a determination that a composed information handling system of the composed information handling systems has been instantiated;
in response to the determination, identifying resource set components allocated to the composed information handling system;
generating a telemetry model for the composed information handling system based on the resource set components; and
configuring the resource set components based on the telemetry model to aggregate operation data generated by the resource set components.

12. The method of claim 11, wherein the resource set components comprise:
a first resource set component hosted by a first information handling system; and
a second resource set component hosted by a second information handling system.

13. The method of claim 12, wherein the first information handling system and the second information handling system are different physical devices.

14. The method of claim 12, wherein configuring the resource set components comprises programming the first resource set component to send first operation data to an aggregation point.

15. The method of claim 14, wherein configuring the resource set components further comprises programming the second resource set component to send second operation data to the aggregation point.

16. A non-transitory computer readable medium comprising computer readable program code, which when executed by a computer processor enables the computer processor to perform a method for managing operation of composed information handling systems, the method comprising:
making a determination that a composed information handling system of the composed information handling systems has been instantiated;
in response to the determination, identifying resource set components allocated to the composed information handling system;
generating a telemetry model for the composed information handling system based on the resource set components; and
configuring the resource set components based on the telemetry model to aggregate operation data generated by the resource set components.

17. The non-transitory computer readable medium of claim 16, wherein the resource set components comprise:
a first resource set component hosted by a first information handling system; and
a second resource set component hosted by a second information handling system.

18. The non-transitory computer readable medium of claim 17, wherein the first information handling system and the second information handling system are different physical devices.

19. The non-transitory computer readable medium of claim 17, wherein configuring the resource set components comprises programming the first resource set component to send first operation data to an aggregation point.

20. The non-transitory computer readable medium of claim 19, wherein configuring the resource set components further comprises programming the second resource set component to send second operation data to the aggregation point.
